(19) United States
(12) Patent Application Publication
(10) Pub. No.: US 2007/0053533 A1
(43) Pub. Date: Mar. 8, 2007

(54) Portable media player with a plurality of audio signal outputs

(75) Inventors: Yuen Khim Joseph Liow, Singapore (SG); Bernard Lim, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 11/220,813

(22) Filed: Sep. 6, 2005

(51) Int. Cl. H04R 5/02

(52) U.S. Cl. 381/311

(57) ABSTRACT

There is provided a portable media player with a plurality of audio signal outputs, including: a storage device; and a controller for processing data in the storage device. Preferably, the data is processed and channeled by the controller into each of the plurality of the audio signal outputs. The data processed and channeled by the controller into each of the plurality of the audio signal outputs may be identical or different. Preferably, the storage device is either solid state memory or a hard disk drive. A wireless transceiver and antennae may also be included in the media player. A channel selector may be present in the media player.

### FIELD OF INVENTION

This invention relates to a portable media player with a plurality of audio signal outputs.

### BACKGROUND

Many portable media players currently in the market have huge storage capacities that are able to contain large numbers of audio files. However, these files are mostly accessible only to a single user at a time. There are currently no players which enable simultaneous multi-user access of the audio files in the media players.

It is also not unusual for the user to have spare storage capacity in the player because of the cost required to purchase songs to store in each player. The capacity would be better utilised if multiple users could store their individual collections and be able to listen to their individual collections simultaneously. Multiple users of a portable media player need no longer listen to the same audio file at any one time.

### SUMMARY

There is provided a portable media player with a plurality of audio signal outputs, including: a storage device; and a controller for processing data in the storage device. Preferably, the data is processed and channeled by the controller into each of the plurality of the audio signal outputs. The data processed and channeled by the controller into each of the plurality of the audio signal outputs may be identical or different. Preferably, the storage device is either solid state memory or a hard disk drive. Each audio signal output may include a earphone jack.

It is preferable that the media player also includes a decoder coupled with each of the plurality of audio signal outputs. It is advantageous that the decoder has a predetermined amount of cache memory. It is also preferable that the decoder includes means to manage the data in the cache memory in ways such as, for example, volume, file selection and sound settings. Each decoder may advantageously be coupled to a channel selector.

Preferably, a listening device is connected to each of the plurality of audio signal outputs. The listening device may be headphones, earphones or speakers. The listening device may either be wired or wireless. Wireless protocols selected for use by the listening device may be Bluetooth, UWB, infrared or radio frequency. It is advantageous that the listening device includes a sound reception device like a microphone.

Preferably, the decoder manipulates the audio signal output by lowering a volume of audio output emitted from the listening device when sound signals above a predetermined level is picked up on the microphone.

It is preferable that the decoder is controllable by a remote control that transmits RF signals.

In an alternative embodiment, the portable media player with a plurality of audio signal outputs as earlier described further includes a wireless transceiver and an antennae for the transmission and reception of data through each audio signal output. This may negate the necessity for the integration of earphone jacks in the media player. In this embodiment, listening devices with antennaes may be coupled wirelessly because of the wireless transceiver. Preferably, the wireless transceiver uses protocols selected from the group comprising: Bluetooth, UWB, infrared and radio frequency.

It is advantageous that each listening device has a channel selector as the wireless transceiver may transmit a plurality of data streams (channels) in continuous discrete packets.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows a schematic diagram of a preferred embodiment of the present invention.

FIG. 2 shows a schematic diagram of an alternative embodiment of the present invention.

FIG. 3 shows a representation of a channel selector component as employed in the preferred embodiment of FIG. 1.

### DESCRIPTION OF PREFERRED EMBODIMENTS

The following discussion is intended to provide a brief, general description of a suitable computing environment in which the present invention may be implemented. As those skilled in the art will appreciate, the invention may be practiced with other computer system configurations, including hand-held devices, multiprocessor systems, microprocessor-based or programmable consumer electronics, minicomputers, and the like.

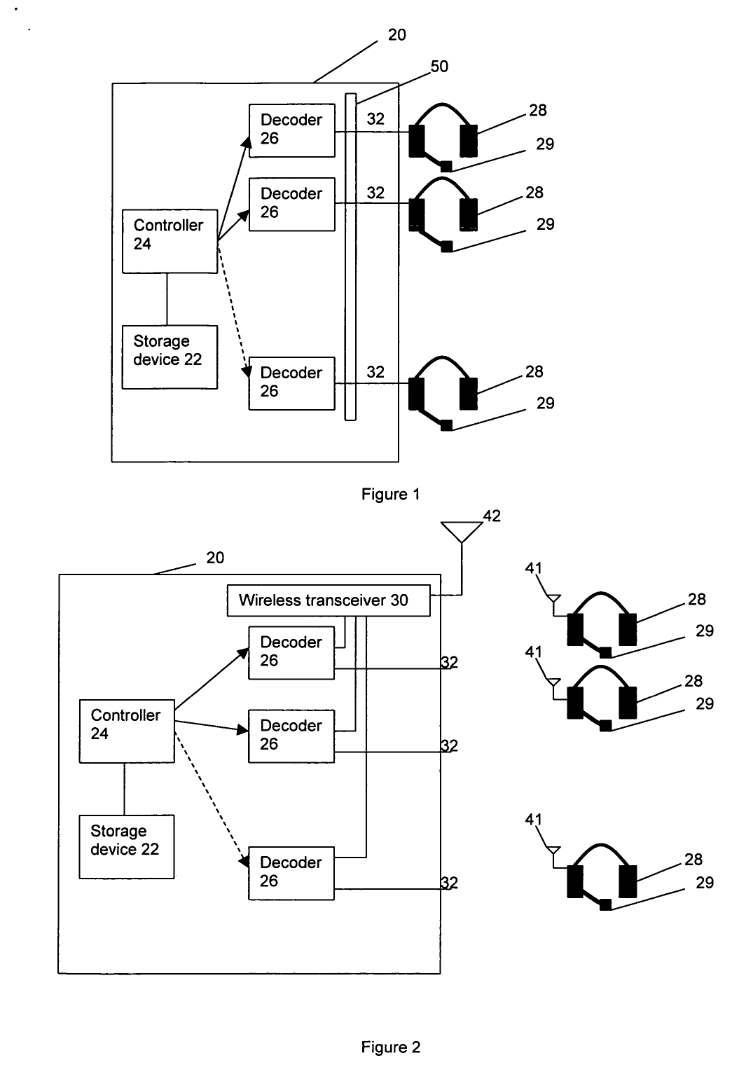

According to a preferred embodiment of the present invention as shown in FIG. 1, there is provided a portable media player 20 with a plurality of audio signal outputs 32. The media player 20 may include a storage device 22. The storage device 22 may be a solid state memory module (flash, RAM) or a hard disk drive. The storage device 22 may have a capacity ranging from several megabytes to several terabytes. The media player 20 may also include an expansion slot for direct connection and access to a separate secondary storage device, such as, for example, a compact flash memory card, a secure digital card and the like.

The media player 20 also includes a controller 24 for processing data in the storage device 22. The controller 24 processes and channels data from the storage device 22 into each of the plurality of the audio signal outputs 32. The total number of outputs 32 may be determined by the processing capability of the controller 24. The better the processing capability of the controller 24, the higher the number of outputs 32 supportable by the player 20.

The data processed and channeled into each output 32 may be identical or different. A listening device 28 may be connected to each of the plurality of audio signal outputs 32. The listening device 28 may be a pair of headphones, a pair of earphones, a set of speakers or the like. There may be a jack for each output 32 for connection to the listening device 28. The listening device 28 may be wired or wireless. The wireless protocols used for the listening device 28 may be Bluetooth, UWB, infrared or radio frequency. The effective range of the wireless listening devices 28 is dependent on the transmission protocol used. Having identical data at each output 32 depicts the instance where each user at each listening device 28 is listening to the same audio output, such as, for example, songs, orchestral pieces, recitals, speeches and so forth. Similarly, having different data at each output 32 depicts the instance where each user at each listening device 28 is listening to differing audio output, such as, for example, songs, orchestral pieces, recitals, speeches and so forth.

Each output 32 should be coupled with a decoder 26. The decoder 26 is used to convert the data stored in the storage device 22 to series of audio signals that is identifiable by a user at the listening device 28 as desired audio output, such as, for example, songs, orchestral pieces, recitals, speeches and so forth. The decoder 26 may have a predetermined amount of cache memory incorporated within. The cache memory is essential for multiple users to access the data stored in the storage device 22.

After the controller 24 processes the users' request for the playback of a file that they desire in the storage device 22, the cache memory in each decoder 26 is over-written with a yet-to-be-played-back predetermined portion of the selected file. The predetermined portion of the selected file may be time-based or file-size based. For example, a thirty-second portion (in terms of playback duration) of the file may be stored or a fraction of the file size may be stored. This allows for the playback of this portion of the file through listening device 28 while the controller 24 “pushes” portions of different files requested at different outputs 32 to each corresponding decoder 26. When the data in the cache memory of each decoder 26 is run, the controller 24 would “push” subsequent portions of the file and overwrite the “played-back” portion of the file once the data in the cache memory of each decoder 26 is run to a predetermined level. This enables playback of desired audio output at each listening device 28.

The decoder 26 may also be able to control the audio output from a corresponding listening device. Parameters of the audio output such as, for example, volume and sound settings may be controllable through the decoder 26. The decoder 26 may also facilitate the selection of files for playback through the listening device 28. The sound settings may include equalizer and/or treble-bass settings.

The listening device 28 may include a sound reception device 29 such as a microphone. The decoder 26 in the media player 20 may lower the volume of the audio output (from file in storage device 22) through the listening device 28 when sound signals above a predetermined level is picked up by the sound reception device 29. The decoder 26 may transmit the sound signals picked up by the sound reception device 29 to at least one other user of the media player 20 to facilitate inter-user communication. In this way, multiple users of the media player 20 may be able to communicate clearly with each other while still being able to listen to their desired audio output through their respective listening devices at a lower volume. This may be useful when the plurality of users of the media player 20 are in separate rooms or are not in close proximity with each other. In this embodiment, each decoder 26 may be transmitting streams of data to each corresponding listening device 28. Each decoder 26 may be coupled to a channel selector 50, where each stream of data from each decoder is a channel. Each listening device 28 may be able to choose which channel to listen to. A channel selector switch may be incorporated into listening device 28 to enable this feature. This facilitates the scenario where a first user may ask a second or another user to listen to the first user's desired output from the media player 20.

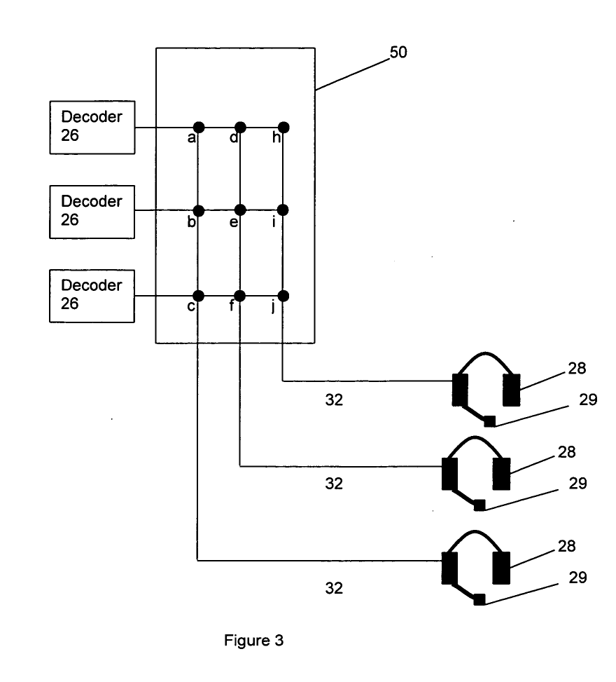

FIG. 3 shows an enlarged representation of the channel selector 50. In a preferred embodiment, every output 32 is connected to each decoder 26 (shown by nodes a-j). Switching between the nodes connected to the different decoders 26 would enable a user to choose which channel to listen to. The switching may be done using a channel selector switch. Hence, the different users may all be listening to the same channel or may all be listening to different channels.

Referring to FIG. 2, there is shown an alternative embodiment of the present invention. In this alternative embodiment, the media player 20 includes a wireless transceiver 30 and an antennae 42 for the transmission and reception of data through each audio signal output 32. The antennae 42 may be incorporated within the casing of media player 20 such that there are no protrusions from the casing of the media player 20. In this embodiment, there may be no connectors/jacks for the coupling of the plurality of listening devices 28 to the media player 20. The plurality of listening devices 28 may be wirelessly connected to the media player 20 using protocols such as, for example, Bluetooth, UWB, infrared or radio frequency. An antennae 41 may be incorporated within listening device 28 such that there are no protrusions from the listening device 28. The effective range of the wireless listening devices 28 is dependent on the transmission protocol used. Other than this aspect, all functions and features of the media player are similar to that described in the preferred embodiment. In this embodiment, the transceiver 30 may be transmitting a plurality of data streams in continuous discrete packets. For example, packets A1, B1 and C1 may be transmitted simultaneously, with packets A2, B2 and C2 being transmitted a predetermined time later. Packet A1 would link up with packet A2, packet B1 would link up with packet B2 and so forth to playback desired material of the various users. Each data stream may be considered a channel and each listening device 28 may be able to choose which channel (A, B or C) to listen to. A channel selector switch may be incorporated into listening device 28 to enable this feature. This facilitates the scenario where a first user may ask a second or another user to listen to the first user's desired output from the media player 20.

The functions of the media player 20 may also be controllable using a wireless RF remote that is able to operate the media player 20 even when the user is in a different room. The wireless RF remote will transmit instructions to a specific decoder 26 and the instructions will determine the audio output emitted from the corresponding listening device 28. As such, multiple users in different areas are able to control and use the media player 20 at their preferred settings.

Whilst there has been described in the foregoing description preferred embodiments of the present invention, it will be understood by those skilled in the technology concerned that many variations or modifications in details of design or construction may be made without departing from the present invention.

1. A portable media player with a plurality of audio signal outputs, including:
a storage device; and
a controller for processing data in the storage device;
wherein the data is processed and channeled by the controller into each of the plurality of the audio signal outputs.

2. The portable media player as claimed in claim 1, wherein the channeled data in each of the plurality of the audio signal outputs is selected from the group comprising: identical and different.

3. The portable media player as claimed in claim 1, wherein the storage device is selected from the group comprising: solid state memory and a hard disk drive.

4. The portable media player as claimed in claim 1, further including a decoder coupled with each of the plurality of audio signal outputs.

5. The portable media player as claimed in claim 4, wherein the decoder has a predetermined amount of cache memory.

6. The portable media player as claimed in claim 5, wherein the decoder includes means to manage the data in the cache memory.

7. The portable media player as claimed in claim 6, wherein the means are selected from the group comprising: volume, file selection and sound settings.

8. The portable media player as claimed in claim 4, wherein a listening device is connected to each of the plurality of audio signal outputs.

9. The portable media player as claimed in claim 8, wherein the listening device is selected from the group comprising: headphones, earphones and speakers.

10. The portable media player as claimed in claim 8, wherein the listening device is connected to the player by the means selected from the group comprising: wired and wireless.

11. The portable media player as claimed in claim 10, wherein the wireless means uses protocols selected from the group comprising: Bluetooth, UWB, infrared and radio frequency.

12. The portable media player as claimed in claim 8, wherein the listening device includes a sound reception device.

13. The portable media player as claimed in claim 12, wherein the sound reception device is a microphone.

14. The portable media player as claimed in claim 1, wherein each audio signal output is includes a earphone jack.

15. The portable media player as claimed in claim 13, wherein the decoder manipulates the audio signal output when sound signals above a predetermined level is picked up on the microphone.

16. The portable media player as claimed in claim 15, wherein the decoder manipulates the audio signal output by lowering a volume of audio output emitted from the listening device.

17. The portable media player as claimed in claim 4, wherein the decoder is controllable by a remote control.

18. The portable media player as claimed in claim 17, wherein the remote control transmits RF signals.

19. The portable media player as claimed in claim 4, further including a channel selector for each decoder.

20. A portable media player with a plurality of audio signal outputs, including:
a storage device;
a controller for processing data in the storage device; and
a wireless transceiver and an antennae for the transmission and reception of data through each audio signal output,
wherein the data is processed and channeled by the controller into each of the plurality of the audio signal outputs.

21. The portable media player as claimed in claim 20, wherein the channeled data in each of the plurality of the audio signal outputs is different.

22. The portable media player as claimed in claim 20, wherein the storage device is selected from the group comprising: solid state memory and a hard disk drive.

23. The portable media player as claimed in claim 20, further including a decoder coupled with each of the plurality of audio signal outputs.

24. The portable media player as claimed in claim 23, wherein the decoder has a predetermined amount of cache memory.

25. The portable media player as claimed in claim 24, wherein the decoder includes means to manage the data in the cache memory.

26. The portable media player as claimed in claim 25, wherein the means are selected from the group comprising: volume, file selection and sound settings.

27. The portable media player as claimed in claim 23, wherein a listening device is coupled to each of the plurality of audio signal outputs.

28. The portable media player as claimed in claim 27, wherein the listening device is wireless and receives data from the wireless transceiver and the antennae.

29. The portable media player as claimed in claim 28, wherein the listening device has an antennae and is selected from the group comprising: headphones, earphones and speakers.

30. The portable media player as claimed in claim 20, wherein the wireless transceiver uses protocols selected from the group comprising: Bluetooth, UWB, infrared and radio frequency.

31. The portable media player as claimed in claim 27, wherein the listening device includes a sound reception device.

32. The portable media player as claimed in claim 31, wherein the sound reception device is a microphone.

33. The portable media player as claimed in claim 32, wherein the decoder manipulates the audio signal output when sound signals above a predetermined level is picked up on the microphone.

34. The portable media player as claimed in claim 33, wherein the decoder manipulates the audio signal output by lowering a volume of audio output emitted from the listening device.

35. The portable media player as claimed in claim 23, wherein the decoder is controllable by a remote control.

36. The portable media player as claimed in claim 35, wherein the remote control transmits RF signals.

37. The portable media player as claimed in claim 27, wherein the listening device further includes a channel selector.

38. The portable media player as claimed in claim 20, wherein the wireless transceiver transmits a plurality of data streams in continuous discrete packets.
